(19) United States
(12) Patent Application Publication
(10) Pub. No.: US 2018/0157757 A1
(43) Pub. Date: Jun. 7, 2018

(54) SYSTEMS AND METHODS FOR GENERATING CONTENT

(71) Applicant: Facebook, Inc., Menlo Park, CA (US)

(72) Inventor: Weiyi Liu, Sunnyvale, CA (US)

(21) Appl. No.: 15/366,762

(22) Filed: Dec. 1, 2016

(51) Int. Cl. G06F 17/30; H04L 29/08

(52) U.S. Cl. CPC G06F 17/30867; H04L 67/02; G06Q 50/01; H04L 67/22; H04L 67/306

(57) ABSTRACT

Systems, methods, and non-transitory computer-readable media can receive a plurality of content items associated with a particular event. An event channel associated with the particular event is generated. The event channel is presented in a content feed.

### FIELD OF THE INVENTION

The present technology relates to the field of content provision. More particularly, the present technology relates to techniques for generating content for users.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

User experience associated with a social networking system can be enhanced as the social networking system becomes more knowledgeable about the users that it serves. When knowledge of a user is gained, content, advertising, tools, and other services can be optimized for presentation to the user. Such potentially helpful knowledge about the user can include information about the user as an individual as well as the user's activity on the social network. Knowledge about the user can be utilized to provide features that increase user interest in and engagement with the social networking system.

### SUMMARY

Various embodiments of the present disclosure can include systems, methods, and non-transitory computer readable media configured to receive a plurality of content items associated with a particular event. An event channel associated with the particular event is generated. The event channel is presented in a content feed.

In an embodiment, receiving the plurality of content items associated with the particular event comprises receiving a plurality of content items posted to a social networking system. Each content item is posted to the social networking system by a posting user. For each content item of the plurality of content items, an indication is received from the posting user that the content item is associated with the particular event.

In an embodiment, for each content item of the plurality of content items, time information associated with the content item is compared to event time information associated with the particular event.

In an embodiment, for each content item in the plurality of content items, location information associated with the content item is compared to event location information associated with the particular event.

In an embodiment, the plurality of content items are ranked based on ranking criteria. The plurality of content items are ordered within the event channel based on the ranking.

In an embodiment, the ranking criteria comprise at least one of: a number of likes received for each content item, a number of times each content item was shared with other users, a number of comments that were posted in response to each content item, a number of users following each content source that posted each content item, a number of users that accessed each content item, an average amount of time spent by users viewing each content item, a video quality of each content item, or a sound quality of each content item.

In an embodiment, the presenting the event channel in the content feed comprises automatically beginning playback of the event channel within the content feed.

In an embodiment, the generating an event channel associated with the particular event comprises determining that there are a threshold number of content items associated with the particular event.

In an embodiment, the presenting the event channel in the content feed comprises determining that a user accessing the content feed is interested in the particular event.

In an embodiment, event information is received for a plurality of events. The plurality of events comprises the particular event.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content provider module, according to an embodiment of the present disclosure.

FIG. 2 illustrates an example content channel module, according to an embodiment of the present disclosure.

FIG. 3 illustrates an example interface, according to an embodiment of the present disclosure.

FIG. 4 illustrates another example interface, according to an embodiment of the present disclosure.

FIG. 5 illustrates an example method associated with generating event channels, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Generating Content

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

User experience associated with a social networking system can be enhanced as the social networking system becomes more knowledgeable about the users that it serves. When knowledge of a user is gained, content, advertising, tools, and other services can be optimized for presentation to the user. Such potentially helpful knowledge about the user can include information about the user as an individual as well as the user's activity on the social network. Knowledge about the user can be utilized to provide features that increase user interest in and engagement with the social networking system.

It continues to be an important interest for a social networking system rooted in computer technology to maximize user engagement with the social networking system. However, it can be difficult to effectively provide products and features that will be of interest to users. This is particularly true given that many users can become overwhelmed by the amount of new content posted on a social networking system, and may become frustrated with trying to comb through the large amounts of content to find content that is interesting. Users becoming overwhelmed with the amount of content available, or becoming frustrated with searching for interesting content, may browse for a short period of time, and then stop looking at new content. When users stop browsing through content even when new content is available, users may miss out on content that may be of interest to them.

An improved approach rooted in computer technology overcomes the foregoing and other disadvantages associated with conventional approaches specifically arising in the realm of computer technology. In some embodiments, users can access event channels (or streams) that correspond to various events. An event channel corresponding to a particular event may include various types of content items that each have been determined to be relevant, or related, to that event. In general, the content items included in an event channel can be posted by various users of the social networking system. When a user posts a content item to a social networking system, the content item can be tagged with an event. Once a threshold number of content items associated with a particular event are posted and identified, an event channel can be formed for that particular event. An event channel can aggregate content items from various users and provide a continuous stream of content items related to a given event for a user to browse. Content items that are tagged with a particular event can be aggregated and ranked based on various ranking criteria. The ranked content items can be presented in the event channel based on the ranking.

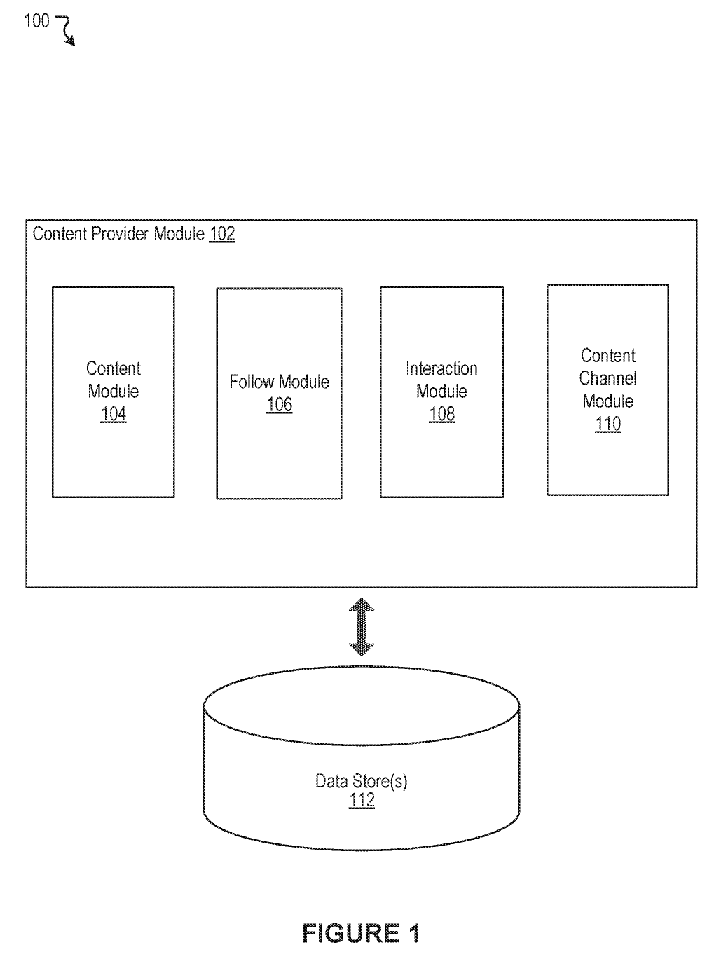

FIG. 1 illustrates an example system 100 including an example content provider module 102, according to an embodiment of the present disclosure. As shown in the example of FIG. 1, the content provider module 102 can include a content module 104, a follow module 106, an interaction module 108, and a content channel module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

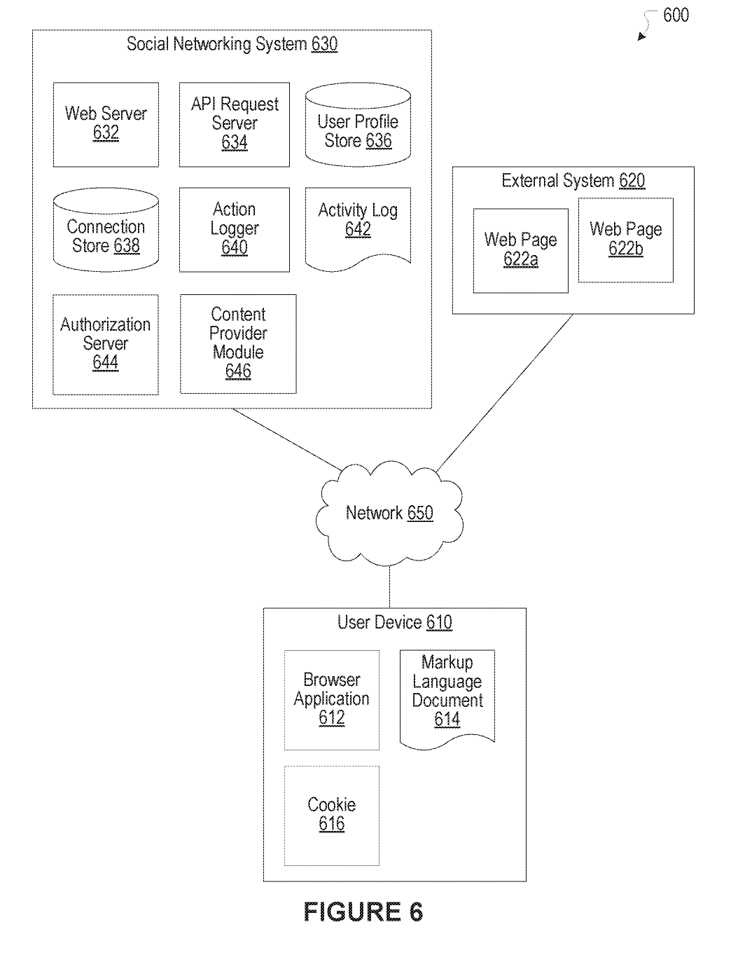

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user or client computing device. In one example, the content provider module 102 or at least a portion thereof can be implemented as or within an application (e.g., app), a program, or an applet, etc., running on a user computing device or a client computing system, such as the user device 610 of FIG. 6. In another example, the content provider module 102 or at least a portion thereof can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6.

The content provider module 102 can be configured to communicate and/or operate with the at least one data store 112, as shown in the example system 100. The at least one data store 112 can be configured to store and maintain various types of data. For example, the data store 112 can store information describing various content that has been posted by users of a social networking system. In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data.

The content provider module 102 can be configured to provide users with access to content that is posted through a social networking system. For example, the content module 104 can provide a first user with access to content items through an interface that is provided by a software application (e.g., a social networking application) running on a computing device of the first user. The first user can also interact with the interface to post content items to the social networking system. Such content items may include text, images, audio, and videos, for example.

In various embodiments, other users of the social networking system can access content items posted by the first user. In one example, the other users can access the content items by searching for the first user through the interface, for example, by user name. In some instances, some users may want to see content items posted by the first user in their respective content feed. To cause content items posted by the first user to be included in their respective content feed, a user can select an option through the interface to subscribe to, or “follow”, the first user. The follow module 106 can process the user's request by identifying the user as a follower of (or “friend” of) the first user in the social networking system. As a result, some or all content items that are posted by the first user can automatically be included in the respective content feed of the user. If the user decides that they no longer want to see content from the first user in their respective content feed, the user can select an option through the interface to “unfollow” the first user. As a result, the follow module 106 can remove the association between the user and the first user so that content items posted by the first user are no longer included in the content feed of the user.

In some instances, the user may want to endorse, or “like”, a content item. In such instances, the user can select an option provided in the interface to like the desired content item. The interaction module 108 can determine when a user likes a given content item and can store information describing this relationship. In some embodiments, information describing user interactions can be stored in a social graph as described in reference to FIG. 6. In some embodiments, the interaction module 108 can determine when a user shares a given content item and can store information describing the content item that was shared and with which users the content item was shared. In some instances, the user may want to post a comment in response to a content item. In such instances, the user can select an option provided in the interface to post a comment in response to the desired content item. The interaction module 108 can determine when a user posts comments for a given content item and can store information describing this relationship.

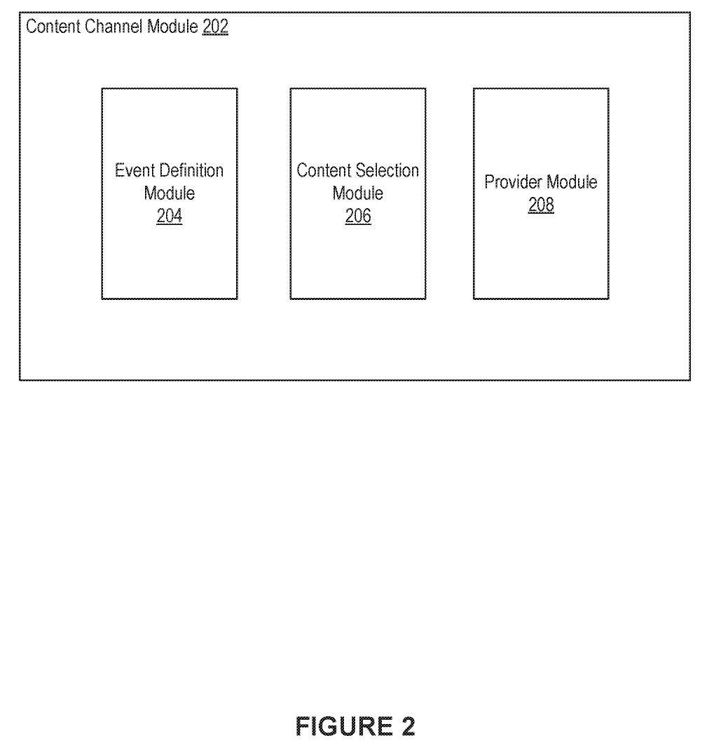

In addition to their respective content feeds, in some embodiments, users can also access event channels that correspond to various events (e.g., a music festival, a concert, a sporting event, a parade, a holiday, etc.). An event channel corresponding to a particular event may include various types of content items that each have been determined to be relevant, or related, to that event. In general, the content items included in an event channel can be posted by various users of the social networking system. In various embodiments, the content channel module 110 is configured to generate event channels using content items that are available from various sources including, for example, any content items that are posted through the social networking system. More details regarding the content channel module 110 will be provided below with reference to FIG. 2.

FIG. 2 illustrates a content channel module 202, according to an embodiment of the present disclosure. In some embodiments, the content channel module 110 of FIG. 1 can be implemented as the content channel module 202. As shown in the example of FIG. 2, the content channel module 202 can include an event definition module 204, a content selection module 206, and a provider module 208.

The event definition module 204 can be configured to define one or more events, and to receive content items associated with a particular event of the one or more events. In certain embodiments, the event definition module 204 can be configured to receive event information associated with one or more events. Event information can include, inter alia, an event name, an event location (i.e., event location information), and an event time (i.e., event time information) (e.g., date, start and end times for the event, etc.). In certain embodiments, event information can be obtained from a third party source, such as a ticket provider. Once event information is received, one or more events can be defined based on the event information. For example, for each event identified by the event information, a social networking system can create an event node associated with the event. Users may be given the ability to upload content items to the social networking system, and to associate content items with various events. For example, if a user attends a concert and uploads a video clip of the concert, the user may be provided with an interface through which the user can “tag” the video with the concert event to indicate that the video is associated with the concert.

In certain embodiments, the social networking system can implement a geo-fence based on event location information and/or a time-fence based on event time information to confirm that content items are associated with a particular event. For example, if a user posts a content item to a social networking system, and attempts to associate the content item with a particular event (e.g., attempts to tag the content item with the event), the social networking system may implement various geographic and/or time-based restrictions on the user's attempt to tag the content item with the particular event. Geographic restrictions can be implemented, for example, by comparing content item location information associated with the content item and event location information associated with a particular content item. The content item can be permitted to be associated with the particular event if the content item location information is within a threshold distance of the event location information. Time-based restrictions can be implemented by, for example, comparing content item time information associated with the content item with event time information associated with the particular event. The content item can be permitted to be associated with the particular event if the content item time information is close in time, e.g., within a threshold amount of time, to the event time information. Or, in another example, the content item can be permitted to be associated with the particular event if the content item time information falls within a start time and an end time of the particular event. In a more concrete example, if a sporting event took place in Los Angeles from 7:30 p.m. PST until 10:30 p.m. PST on Nov. 1, 2016, but a content item was recorded on Oct. 12, 2014, in Chicago, Ill., the user may be prohibited from associating the content item with the sporting event. However, if the content item was recorded at 9:00 p.m. PST within a threshold geographic distance from the stadium in which the sporting event took place, the user may be permitted to associate the content item with the sporting event. Time information associated with a content item may be determined based on when the content item was recorded and/or based on when the content item was uploaded to the social networking system. Similarly, location information associated with a content item may be determined based on where the content item was recorded and/or where the content item was uploaded to the social networking system.

The content selection module 206 can be configured to select content items for inclusion in an event channel. As users upload content items to a social networking system and associate the content items with various events, a particular event may have one or more content items associated with it. In certain embodiments, an event channel can be created for a particular event once the particular event has a threshold number of content items associated with it. When an event channel is created for a particular event, one or more content items associated with the particular event (e.g., all content items tagged with the particular event) can be collected for potential inclusion in the event channel. In various embodiments, content items associated with a particular event can be selected, ordered, and/or ranked, so that the best content items can be presented through the event channel. Depending on the implementation, content items associated with a particular event can be ranked based on various ranking criteria. For example, ranking criteria can include any combination of: a number of likes received for a content item; a number of times a content item was shared with other users; a number of comments that were posted in response to a content item; a number of users following a content source that posted a content item; a number of users that, after viewing a content item, begin following the content source that posted the content item; a number of users that accessed a content item; an average amount of time spent by users viewing a content item; whether a content item is trending in popularity among users; the video quality of a content item; the sound quality of a content item; and/or an amount of time since a content item was posted, to name some examples. In certain embodiments, content items can be ordered in an event channel based on the ranking.

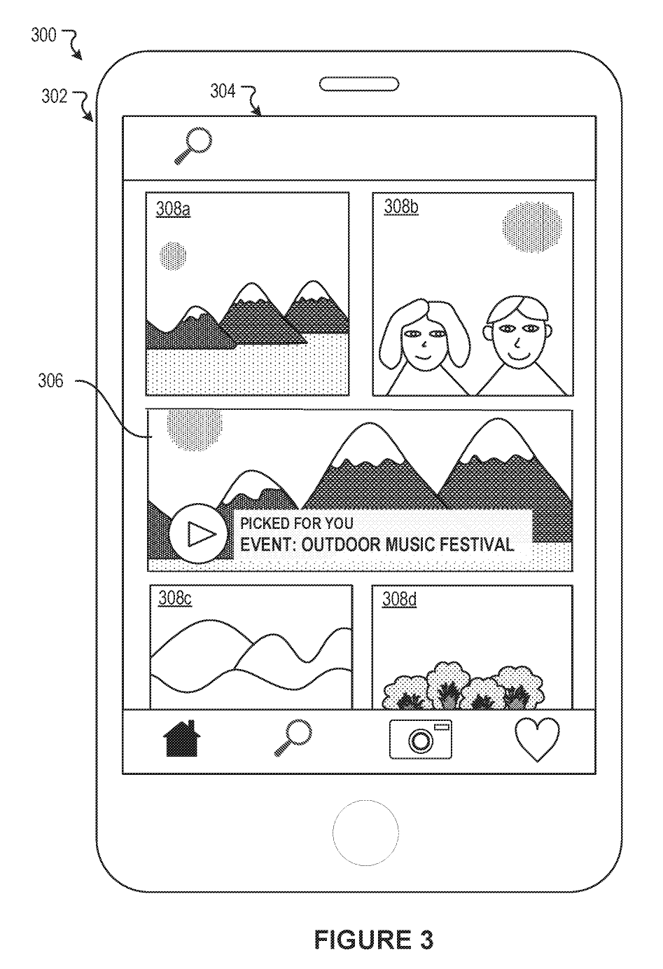

The provider module 208 can be configured to determine a set of event channels to be presented to a user through an interface, as illustrated in the example of FIG. 3. In certain embodiments, event channels can be presented in a content feed. The content feed can comprise a plurality of content items for viewing and/or interaction by a user, including the event channel. Content items presented in the content feed, including the event channel, may be selected for inclusion in the content feed based on a determination that the content items are of interest to a user accessing the content feed. For example, an event channel associated with a particular event may be presented to the user based on a determination that the user is interested in the particular event. In some embodiments, the provider module 208 can determine which event channels to provide to a user based on any content sources that are being followed by the user. For example, the provider module 208 can determine that a user follows a user account of a pop musician. In this example, the provider module 208 can identify one or more event channels based in part on the user following the popular musician (e.g., an event channel associated with a concert for that musician, or a music festival in which the musician performed).

In certain embodiments, a cover content item can be selected for an event channel. The cover content item can be a content item that is presented as a “cover” for the event channel within the content feed. In certain embodiments, so as to attract viewers to the event channel, the cover content item can be selected based on the video quality of the content item. In certain embodiments, the cover content item can be selected based on the ranking of the content items for the event channel. For example, the cover content item can be the top ranked content item.

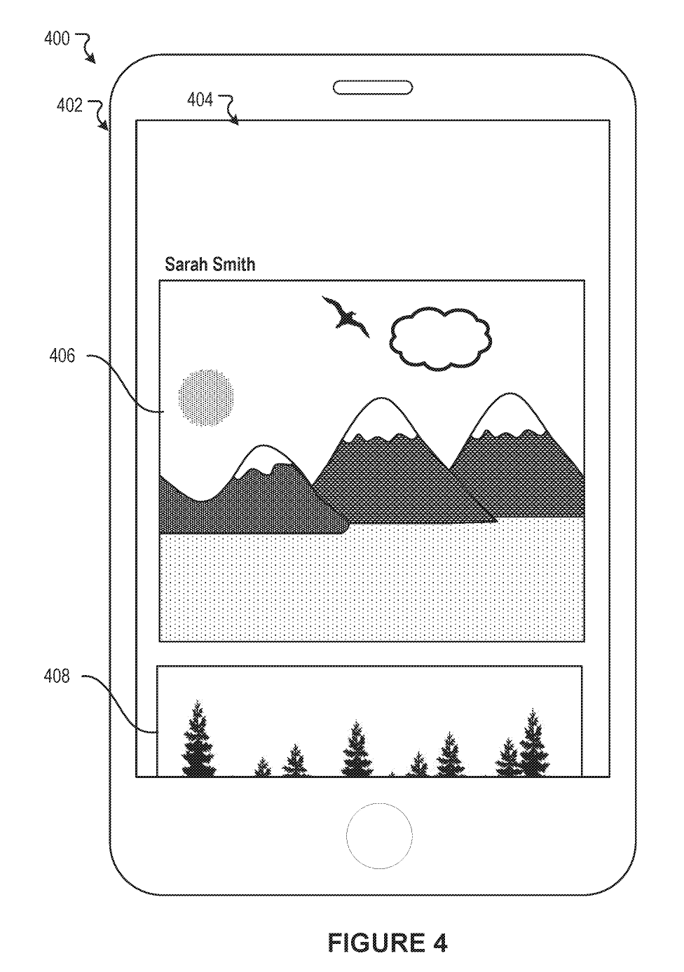

When a user selects an event channel within a content feed, an immersive interface can be opened in which the event channel is presented. The immersive interface can allow a user to scroll through, view, and/or interact with the plurality of content items contained in the event channel. For example, in certain embodiments, the immersive interface can present in a central portion of the immersive interface a currently playing content item. In another region of the immersive interface, e.g., in a lower portion of the interface, a “next” content item can be presented such that a user can scroll to the next content item to view and/or begin playback of the next content item. In another portion of the interface, e.g., an upper portion of the interface, a “previous” content item can be presented so that the user can scroll back through previously viewed content items in the event channel. An example immersive interface will be presented and described with respect to FIG. 4.

FIG. 3 illustrates an example 300 of an interface 304, according to an embodiment of the present disclosure. In this example, the interface 304 is presented through a display screen of a computing device 302. Further, the interface 304 may be provided through an application (e.g., a web browser, a social networking application, messenger application, etc.) running on the computing device 302 that is configured to interact with a social networking system. The interface 304 is a content feed that includes a number of different options for accessing content through the social networking system. In this example, the interface 304 includes a region through which a user operating the computing device 302 can access an event channel 306. The event channel 306 is associated with a fictional event “Outdoor Music Festival.” A cover content item of the event channel 306 is presented in the interface 304. The interface 304 also includes regions through which a user operating the computing device 302 can access additional content items 308a-d. In some embodiments, the event channel 306 begins playing content automatically in its corresponding region of the interface 304 as soon as it is displayed in the interface 304. The interface 304 is provided merely as an example and, naturally, many variations in the organization of content items and channels are possible. In addition to event channels, in some embodiments, the interface 304 can include other types of channels such as personalized channels for the user, topic channels, and editorial channels, to name some examples. In some embodiments, upon selecting an event channel, the software application can be configured to provide an immersive interface that presents content items that are included in the event channel, as illustrated in the example of FIG. 4.

FIG. 4 illustrates an example 400 of an interface 404, according to an embodiment of the present disclosure. In this example, the interface 404 is presented through a display screen of a computing device 402. Further, the interface 404 may be provided through an application (e.g., a web browser, a social networking application, messenger application, etc.) running on the computing device 402 that is configured to interact with a social networking system. In this example, the interface 404 is an immersive interface that is being presented in response to an event channel being selected, as described in reference to FIG. 3. The interface 404 presents content items that correspond to the selected event channel. In this example, the interface 404 is presenting a content item 406. The content item 406 is presented with the name of the user that posted the content item, Sarah Smith. In certain embodiments, the content items included in the event channel can individually be presented through the interface 404. In some embodiments, a portion of a next content item to be presented is shown in the interface 404. In example 404, below the content item 406 appears a portion of another content item 408 of the event channel. In certain embodiments, a portion of a previous content item can be shown in the interface 404 (e.g., above the currently playing content item 406) so as to give a user a preview of the content items that come before and after the currently presented content item. In the example 400, after content item 406 is presented, the event channel can automatically transition to the next content item, e.g., content item 408. When the event channel transitions to a next content item, the textual overlay of the user name can be updated to display the name of the user that posted the next content item. Content items can be sequentially presented until all content items in the event channel are presented or until a user takes an action that stops playback of the event channel.

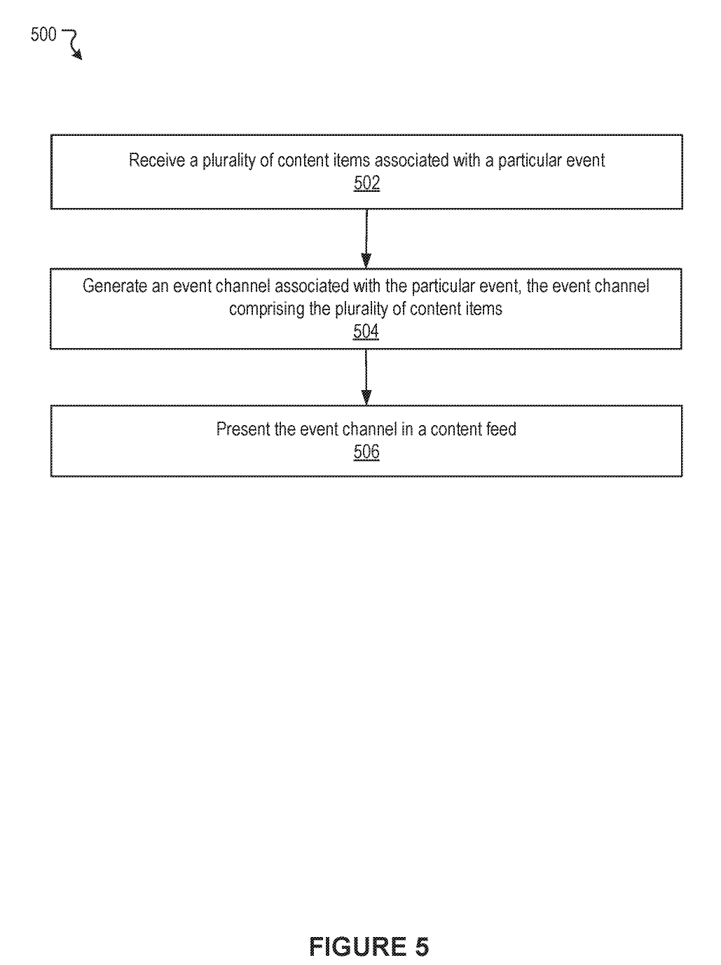

FIG. 5 illustrates an example method 500 for generating event channels, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive a plurality of content items associated with a particular event. At block 504, the example method 500 can generate an event channel associated with the particular event, the event channel comprising the plurality of content items. At block 506, the example method 500 can present the event channel in a content feed.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102, as discussed in more detail herein. As discussed previously, it should be appreciated that there can be many variations or other possibilities. For example, in some embodiments, one or more functionalities of the content provider module 646 can be implemented in the user device 610.

### Hardware Implementation

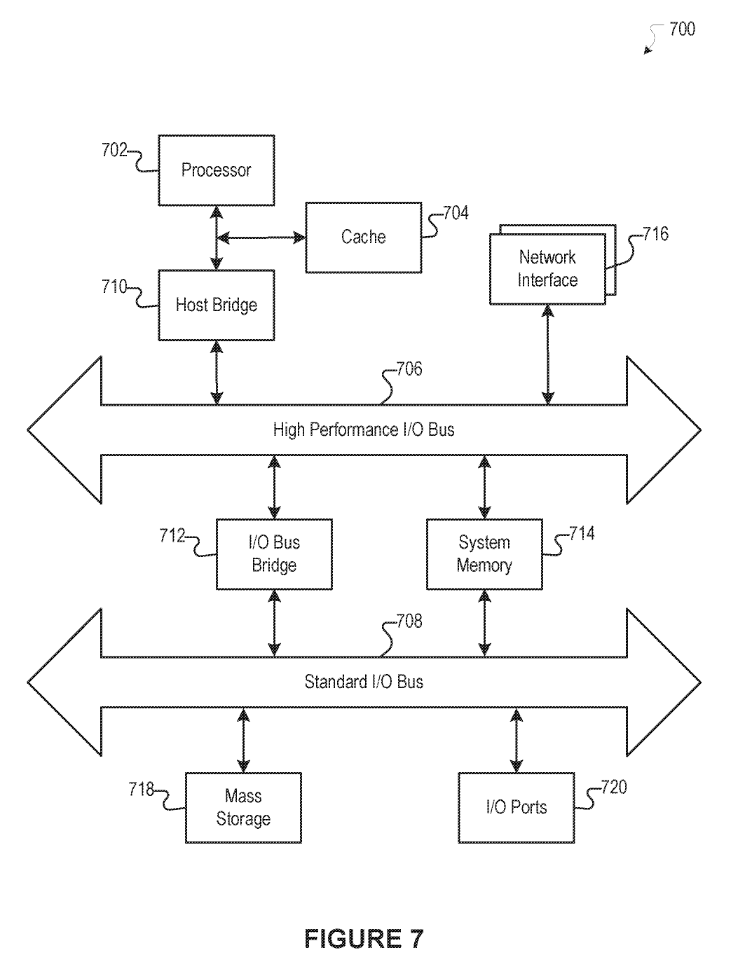

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a plurality of content items associated with a particular event;
generating, by the computing system, an event channel associated with the particular event; and
presenting, by the computing system, the event channel in a content feed.

2. The computer-implemented method of claim 1, wherein the receiving the plurality of content items associated with the particular event comprises:
receiving a plurality of content items posted to a social networking system, each content item posted to the social networking system by a posting user; and
for each content item of the plurality of content items, receiving from the posting user an indication that the content item is associated with the particular event.

3. The computer-implemented method of claim 1, wherein the receiving the plurality of content items associated with the particular event comprises:
for each content item of the plurality of content items, comparing time information associated with the content item to event time information associated with the particular event.

4. The computer-implemented method of claim 1, wherein the receiving the plurality of content items associated with the particular event comprises:
for each content item of the plurality of content items, comparing location information associated with the content item to event location information associated with the particular event.

5. The computer-implemented method of claim 1, further comprising ranking the plurality of content items based on ranking criteria,
wherein the plurality of content items are ordered within the event channel based on the ranking.

6. The computer-implemented method of claim 5, wherein the ranking criteria comprise at least one of: a number of likes received for each content item, a number of times each content item was shared with other users, a number of comments that were posted in response to each content item, a number of users following each content source that posted each content item, a number of users that accessed each content item, an average amount of time spent by users viewing each content item, a video quality of each content item, or a sound quality of each content item.

7. The computer-implemented method of claim 1, wherein the presenting the event channel in the content feed comprises automatically beginning playback of the event channel within the content feed.

8. The computer-implemented method of claim 1, wherein the generating an event channel associated with the particular event comprises determining that there are a threshold number of content items associated with the particular event.

9. The computer-implemented method of claim 1, wherein the presenting the event channel in the content feed comprises determining that a user accessing the content feed is interested in the particular event.

10. The computer-implemented method of claim 1, further comprising receiving event information for a plurality of events, the plurality of events comprising the particular event.

11. A system comprising:
at least one processor; and
a memory storing instructions that, when executed by the at least one processor, cause the system to perform a method comprising:
receiving a plurality of content items associated with a particular event;
generating an event channel associated with the particular event; and
presenting the event channel in a content feed.

12. The system of claim 11, wherein the receiving the plurality of content items associated with the particular event comprises:
receiving a plurality of content items posted to a social networking system, each content item posted to the social networking system by a posting user; and
for each content item of the plurality of content items, receiving from the posting user an indication that the content item is associated with the particular event.

13. The system of claim 11, wherein the receiving the plurality of content items associated with the particular event comprises:
for each content item of the plurality of content items, comparing time information associated with the content item to event time information associated with the particular event.

14. The system of claim 11, wherein the receiving the plurality of content items associated with the particular event comprises:
for each content item of the plurality of content items, comparing location information associated with the content item to event location information associated with the particular event.

15. The system of claim 11, wherein the method further comprises ranking the plurality of content items based on ranking criteria,
wherein the plurality of content items are ordered within the event channel based on the ranking.

16. A non-transitory computer-readable storage medium including instructions that, when executed by at least one processor of a computing system, cause the computing system to perform a method comprising:
receiving a plurality of content items associated with a particular event;
generating an event channel associated with the particular event; and
presenting the event channel in a content feed.

17. The non-transitory computer-readable storage medium of claim 16, wherein the receiving the plurality of content items associated with the particular event comprises:
receiving a plurality of content items posted to a social networking system, each content item posted to the social networking system by a posting user; and
for each content item of the plurality of content items, receiving from the posting user an indication that the content item is associated with the particular event.

18. The non-transitory computer-readable storage medium of claim 16, wherein the receiving the plurality of content items associated with the particular event comprises:
for each content item of the plurality of content items, comparing time information associated with the content item to event time information associated with the particular event.

19. The non-transitory computer-readable storage medium of claim 16, wherein the receiving the plurality of content items associated with the particular event comprises:
for each content item of the plurality of content items, comparing location information associated with the content item to event location information associated with the particular event.

20. The non-transitory computer-readable storage medium of claim 16, wherein the method further comprises ranking the plurality of content items based on ranking criteria,
wherein the plurality of content items are ordered within the event channel based on the ranking.
